(19) United States
(12) Patent Application Publication
(10) Pub. No.: US 2023/0030205 A1
(43) Pub. Date: Feb. 2, 2023

(54) Power-Generating Systems

(71) Applicant: Nghe Xuan Pham, Kenner, LA (US)

(72) Inventor: Nghe Xuan Pham, Kenner, LA (US)

(21) Appl. No.: 17/389,638

(22) Filed: Jul. 30, 2021

(51) Int. Cl. B60L 8/00; B60K 6/28; B60L 53/52; F03D 9/32

(52) U.S. Cl. CPC B60L 8/006; B60K 6/28; B60L 53/52; F03D 9/32; B60Y 2200/92; F05B 2240/941

(57) ABSTRACT

Air stream-driven power-generating systems for electric vehicles have been described and illustrated.

### FIELD

The present patent application, in general, describes systems using an air stream to generate electric power, and more particularly, describes systems using channeled air streams to charge and/or recharge battery-powered electric vehicles.

### BACKGROUND

In the prior art, the development of wind power-based mechanisms to power electric vehicles is known. See, for example, WO 2013/094808 (27.06.2013); PCT/KR2012/000425 (18.01.2012) to CHUNG; U.S. Pat. 6,882,059 to DePaoli; U.S. Pat. 6,897,575 to Yu; U.S. Pat. 8,169,182 to Kimble; US 8,710,691 to Haddad; U.S. Pat. 9,428,061 to Ripley; US Publication 2011/0031043 to Armani et al.; US Publication 2011/0100731 to Hassan; and US Publication 2012/0085587 to Drouin.

Because I, too, am interested in developing wind power-based mechanisms to power electric vehicles, I carefully reviewed the prior art and discovered that systems disclosed in the prior art have not solved the problem of “drag” upon the vehicle imposed by the wind power-based mechanisms (see, for example, US Publication 2020/0398677 to Fiello et al.; US Publication 2012/0085587 to Drouin; US Publication 2011/0031043 to Armani et al.) or caused by operation of the wind power-based mechanisms disclosed. In particular, upon reviewing the prior art, it became clear to me that wind power-based mechanisms to power electric vehicles, disclosed, e.g., in U.S. Pat. 6,897,575 to Yu; U.S. Pat. 8,169,182 to Kimble; US 8,710,691 to Haddad; U.S. Pat. 9,428,061 to Ripley; US Publication 2012/0085587 to Drouin, actually create drag at the back side of the vehicle, which is undesirable.

### SUMMARY

Therefore, to solve the problem of drag, ordinarily created at the back side of an electric vehicle, by operation of wind power-based mechanisms designed to charge or recharge at least one battery of the electric vehicle, I developed a system comprising at least two air stream-powered mechanisms. In particular, I discovered ways to utilize at least two air streams to “balance” air flow while minimizing drag, which surprisingly results in a vacuum region being created at the back side of the vehicle which is desirable, as the vacuum region has been found to provide thrust.

In particular, where there are only two power-generating systems, each is configured to generate electricity suitable for charging and/or recharging the at least one battery of the electric vehicle that is being powered along a road surface.

An illustrative electric vehicle has a front surface and a back surface that is “spaced from” the front surface. In other words, the front surface is along the front of the vehicle and the back surface, being “spaced from” the back, is along the back.

To balance air flow, I designed two elongated tubes, which I call “channels,” for inclusion within the design of the vehicle. Each of the two tubes is arranged to draw an air stream from the vehicle front side and exhaust its air stream from the vehicle back side. More particularly, the two air streams, as a result of my present design, are channeled essentially along a path aligned with the direction of the vehicle, which I discovered creates a vacuum region at the back side of the vehicle.

### BRIEF DESCRIPTION OF THE DRAWINGS

The foregoing, as well as various features and advantages of my present invention, will become better understood after reading my detailed description of the illustrated embodiments, together with my reference to the drawings, wherein:

FIG. 1 is a side elevational view of a conventional electric vehicle, which I have modified to incorporate spaced-apart tubes (or channels) mentioned above.

FIG. 2 is yet another side elevational view of the electric vehicle shown in FIG. 1, with a particular FEATURE of my present novel design encircled and noted.

FIG. 3 is a plan view of the FEATURE of my design, which is noted in FIG. 2.

FIG. 4 depicts a side elevational view of one of the tubes (or channels) mentioned above, as depicted within the region identified by the lines 4-4 in FIG. 1.

FIG. 5 is a plan view of yet another component of my design, namely a wind-turbine generator, as viewed from a plane defined by the lines 5-5 in FIG. 4.

FIG. 6 is a plan view of another wind-turbine generator, as viewed below the channel shown in FIG. 4, and from a plane defined by the lines 6-6 in FIG. 4.

Throughout my drawing figures and the detailed description (below), I shall use similar reference numerals to refer to similar components of my novel design.

### DETAILED DESCRIPTION

For purposes of this specification, it will be clearly understood by those of ordinary skill in the field of the present subject matter: that the term “electric vehicle” (“EV”) includes but is not limited to a bus, car, truck, and van that is propelled along a surface (“S”) by one or more electric motors, using energy stored in at least one rechargeable battery; that the term surface (“S”) includes but is not limited to a country road, a city street, and a high-speed highway; and that the term “hybrid electric vehicle” shall be understood as referring to a type of electric vehicle incorporating an engine using conventional petroleum-derived fuel for propulsion.

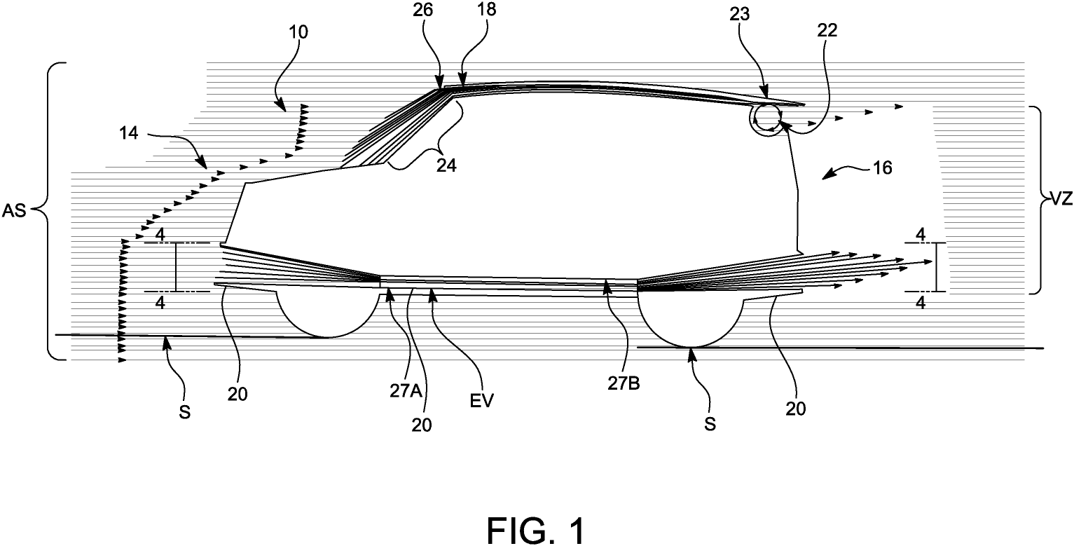

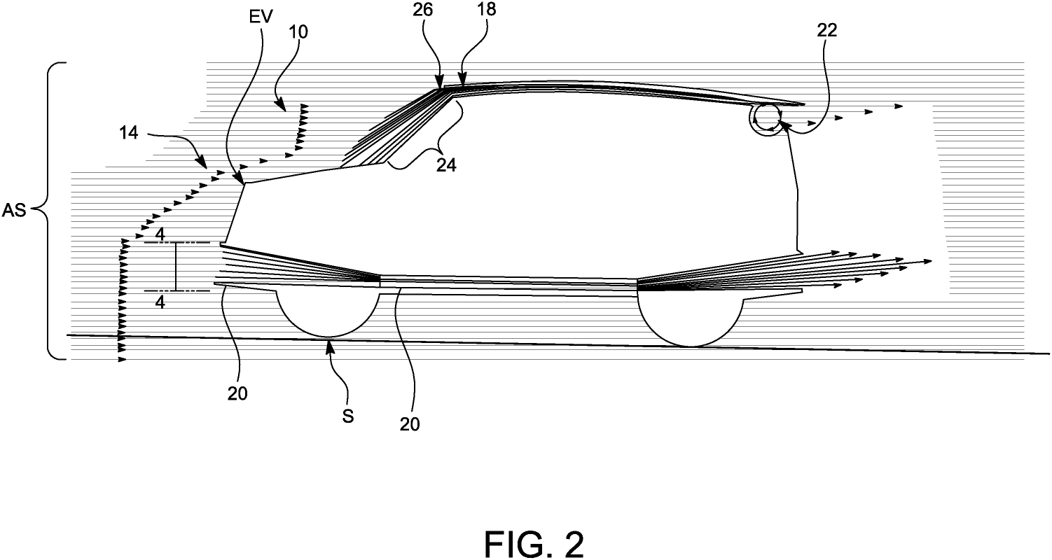

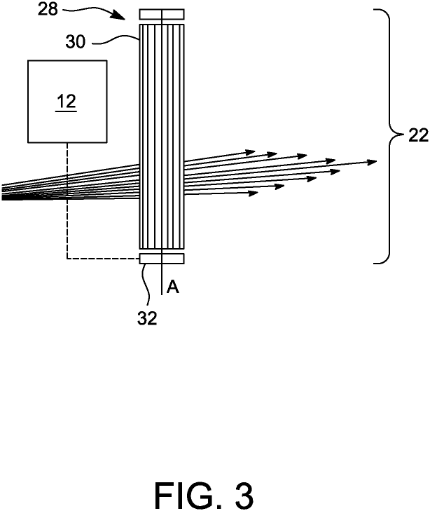

To begin my detailed description of the present subject matter, please refer to FIGS. 1, 2 in which is presented, in a simple outline fashion (FIG. 1), a conventional electric vehicle (“EV”), propelled along a road surface (“S”), incorporating components of the present subject matter which I shall now describe. A FEATURE, noted in FIG. 2, shall be discussed in detail in connection with FIG. 3. Horizontal lines, shown in FIGS. 1, 2, and 4-6 shall be understood to relate to air stream flow.

A power-generating system 10 for use by an electric vehicle (“EV”) powered by at least one battery 12 —see FIG. 3— includes certain components, a few of which I will now discuss in connection with a conventional electric vehicle (“EV”). For instance, the electric vehicle (“EV”) shown in FIGS. 1, 2 includes a front surface 14 and a back surface 16 located at the opposite end of the electric vehicle (“EV”). The electric vehicle (“EV”) also includes a first tube or channel 18 serving to pass an air stream from adjacent the front surface 14 toward the back surface 16. The electric vehicle (“EV”) further includes a second tube or channel 20, also serving to pass an air stream from the front surface 14 to the back surface 16. The first and second channels 18, 20 are aligned with the direction-of-travel of the electric vehicle (“EV”) over the road surface (“S”). Also, as depicted in FIGS. 1 and 2, the first channel 18 is located “closely adjacent” the upper surface of electric vehicle (“EV”), while the second channel 20 is located “closely adjacent” the undercarriage surface of vehicle (“EV”). I shall discuss the spacing between the first and second channels 18, 20 in greater detail, below, in connection with “balancing” of the air streams.

While the power-generating system 10 of the present subject matter can include two air stream-powered mechanisms, the figures depicting an embodiment of the present subject matter present three such air stream-powered mechanisms.

A first air stream-powered mechanism 22 is located adjacent an air stream outlet 23 of the first channel 18. (See FIG. 1.) The first air stream-powered mechanism 22 is fed the air stream being discharged from the first channel 18 via the outlet 23. The first air stream-powered mechanism 22 is contained within an enclosure that is unitary with the first channel 18, which results in substantially all of the air stream that is discharged from first channel 18 being used to power first air stream-powered mechanism 22, which is preferably located “closely adjacent,” meaning about 6 inches or less, from the back surface 16 of electric vehicle (“EV”).

A front windshield 24 of the electric vehicle (“EV”), depending on the speed at which the electric vehicle (“EV”) is driven over the road surface (“S”), will cause a portion of the air stream (“AS”) into which the vehicle is being driven to become pressurized before entering an inlet 26 of the first channel 18. As a result, whenever the electric vehicle (“EV”) is driven over a road surface (“S”) at normal speeds, pressurized air is thus caused to power the first air stream-powered mechanism 22.

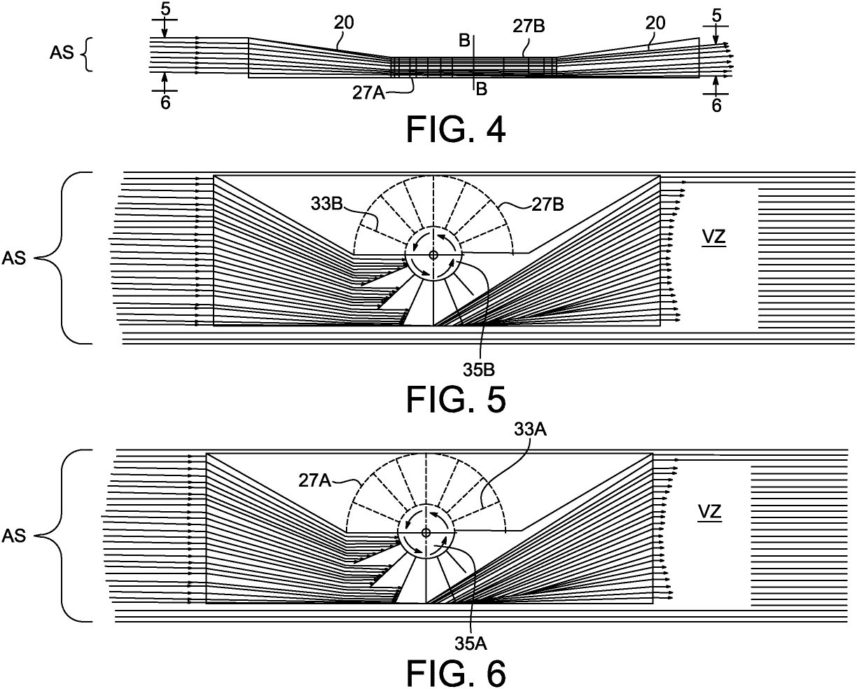

While the scope of present subject matter includes employing a single air stream-powered mechanism within the second channel 20, I prefer employing two such air stream-powered mechanisms (schematically depicted in FIG. 1 and shown in greater detail in FIGS. 4-6) which I shall collectively refer to throughout this specification as a pair of second air stream-powered mechanisms 27A and 27B.

The first air stream-powered mechanism 22 includes an elongated drum 28 rotatable about a first axis (“A”). The first axis (“A”) is oriented (or disposed) transverse to the ordinary (or otherwise normal) direction of travel of the electric vehicle (“EV”) over the road surface (“S”). In order to maximize the efficiency of operation of the electric vehicle (“EV”), the drum 28 is preferably dimensioned lengthwise to be slightly less than a side-to-side length value of the electric vehicle.

The drum 28 includes a plurality of wings or blades 30. Each blade 30, aligned with the first axis (“A”), extends radially outwardly from an exterior surface of the drum 28. Each blade 30 is spaced circumferentially about the exterior surface of the drum 28. Also, each blade 30 is equally spaced circumferentially, from its two nearest neighbor blades 30, around the exterior surface of the drum 28. Air flow from first channel 18, causing rotation of drum 28 about first axis (“A”), drives a turbine 32, connected to the drum 28, thereby charging and/or recharging battery 12, operatively connected to turbine 32, as depicted in the schematic of FIG. 3.

The air stream-powered mechanisms of the present subject matter are each configured to generate electricity sufficient to charge and/or recharge battery 12.

Referring now to FIGS. 4-6, the above-mentioned pair of second air stream-powered mechanisms 27A, 27B shall now briefly be described. Both of the second air stream-powered mechanisms 27A, 27B are contained within the second channel 20, as illustrated by FIG. 4. Also, both of the second air stream-powered mechanisms 27A, 27B rotate about a second axis “B” which is oriented vertically (preferably oriented perpendicularly) relative to the road surface (“S”). One of the pair of second air stream-powered mechanisms 27A, closer to the road surface (“S”), rotates clockwise about the second axis “B” while the other one of the pair of second air stream-powered mechanisms 27B, further from road surface (“S”), rotates counterclockwise about the second axis “B” when viewed from above the electric vehicle (“EV”) and looking down toward road surface (“S”). (See FIGS. 1, 4.) Both of the second air stream-powered mechanisms 27A, 27B include respective blades 33A, 33B and associated respective turbines 35A, 35B. As a result, when operatively connected to battery 12, each one of the pair of second air stream-powered mechanisms 27A, 27B is able to charge and/or recharge the battery 12.

I have discovered that an electric vehicle (“V”) with a pair of spaced-apart channels 18, 20 that are each aligned with the path-of-travel of the electric vehicle (“EV”) over a road surface (“S”), where the channels 18, 20 each discharge a pressurized air stream from the back side 16 of the electric vehicle (“EV”), balances the discharged pressurized air streams, causing a vacuum zone (“VZ”) to be created along the back side 16, creating thrust to power the electric vehicle (“EV”) forward. (See FIGS. 1, and 4-6.) Thus, balanced pressurized air streams, as above described, were found to increase the forward propulsion efficiency of such electric vehicles.

Air stream-driven power-generating systems for electric vehicles have been described and illustrated. While such systems have been described and illustrated with reference to certain embodiments, the present subject matter is not limited to these embodiments. On the contrary, alternatives, changes or modifications may become apparent to one of ordinary skill in the field of the present subject matter after reading this specification. Accordingly, all such alternatives, changes and/or modifications are to be considered as forming a part of the present subject matter insofar as they fall within the spirit and scope of the appended claims.

I claim:

1. A power-generating system for use with a hybrid vehicle that is at least partially-powered by at least one battery comprising:
at least two air stream-powered mechanisms, wherein each one of the at least two air stream-powered mechanisms is configured to generate electricity sufficient to charge and/or recharge the at least one battery;
wherein the hybrid vehicle is at least partially-powered along a road surface by the at least one battery;
wherein the hybrid vehicle defines:
a front surface and a back surface spaced from the front surface,
a first channel to pass air from the front surface to the back surface and
a second channel to pass air from the front surface to the back surface and being disposed between the first channel and the road surface;
wherein one of the at least two air stream-powered mechanisms is adjacent one of the first and second channels and the other one of the at least two mechanisms is disposed in the other of the first and second channels;
wherein the at least two mechanisms are each operatively connected to the at least one battery to charge and/or recharge the at least one battery.

2. A power-generating system for use with an electric vehicle powered by at least one battery comprising:
at least two air stream-powered mechanisms, wherein each one of the at least two air stream-powered mechanisms is configured to generate electricity sufficient to charge and/or recharge the at least one battery;
wherein the electric vehicle is powered along a road surface by the at least one battery;
wherein the electric vehicle defines:
a front surface and a back surface spaced from the front surface,
a first channel to pass air from the front surface to the back surface and
a second channel to pass air from the front surface to the back surface and being disposed between the first channel and the road surface;
wherein one of the at least two air stream-powered mechanisms is adjacent one of the first and second channels and the other one of the at least two mechanisms is disposed in the other of the first and second channels;
wherein the at least two mechanisms are each operatively connected to the at least one battery to charge and/or recharge the at least one battery.

3. The power-generating system of claim 2, wherein each one of the at least two air stream-powered mechanisms includes an air stream-driven turbine that is capable of generating electricity to charge and/or recharge the at least one battery.

4. The power-generating system of claim 3, wherein one of the air stream-driven turbines is disposed in the first channel and rotates about a first axis that is disposed substantially parallel with the road surface and that is also disposed substantially transverse to a direction of travel along the road surface of the vehicle, wherein an other one of the at least two air stream-driven turbines rotates about a second axis that is disposed substantially perpendicular to the road surface.

5. The power-generating system of claim 4, wherein the one of the turbines that rotates about the first axis is disposed adjacent the back surface of the vehicle.

6. A power-generating system for use with an electric vehicle powered by at least one battery comprising:
at least three air stream-powered mechanisms, wherein each one of the at least three air stream-powered mechanisms is configured to generate electricity sufficient to charge and/or recharge the at least one battery;
wherein the electric vehicle is powered along a road surface by the at least one battery;
wherein the electric vehicle defines:
a front surface and a back surface spaced from the front surface,
a first channel to pass air from the front surface to the back surface and
a second channel to pass air from the front surface to the back surface and being disposed between the first channel and the road surface;
wherein one of the at least three air stream-powered mechanisms is disposed adjacent one of the first and second channels and at least two other ones of the at least three air stream-powered mechanisms are both disposed in the other of the first and second channels; and
wherein the at least three air stream-powered mechanisms are each operatively connected to the at least one battery for charging and/or recharging the at least one battery.

7. The power-generating system of claim 6, wherein each one of the at least three air stream-powered mechanisms includes an air stream-driven turbine capable of generating electricity to charge and/or recharge the at least one battery.

8. The power-generating system of claim 7, wherein one of the air stream-driven turbines is disposed in the first channel and is caused by an airstream passing through the first channel to rotate about a first axis that is disposed substantially parallel with the road surface and also disposed substantially transverse to a direction of travel of the vehicle along the road surface, wherein at least two other ones of the at least three air stream-driven turbines disposed in the second channel each are caused by an air stream passing through the second channel, to rotate about a second axis that is disposed substantially perpendicular to the road surface.

9. The power-generating system of claim 8, wherein the one of three turbines that rotates about the first axis is disposed adjacent the back surface of the vehicle.

10. The power-generating system of claim 8, wherein the one of the three turbines rotating about the first axis is closely adjacent to the vehicle back surface.

11. The power-generating system of claim 8, wherein one of the at least two other ones of the at least three air stream-driven turbines rotates clockwise about the second axis relative to an upper surface of the vehicle and an other one of the at least two other ones of the at least three air stream-driven turbines rotates counterclockwise about the second axis relative to an upper surface of the vehicle.

12. The power-generating system of claim 11, wherein the first channel defined by the vehicle is disposed adjacent the upper surface of the vehicle, and wherein the first channel includes an inlet, also defined by the vehicle, that is so located on the vehicle as to smoothly introduce an air stream into the first channel, for causing the one of the air stream-driven turbines disposed therein to power the vehicle.
